(19) United States
(12) Patent Application Publication
(10) Pub. No.: US 2020/0117955 A1
(43) Pub. Date: Apr. 16, 2020

(54) RECOVERING IMAGES FROM COMPRESSIVE MEASUREMENTS USING MACHINE LEARNING

(71) Applicant: Nokia Technologies Oy, Espoo (FI)

(72) Inventors: Hong Jiang, Warren, NJ (US); Jong Hoon Ahn, Bound Brook, NJ (US); Xiaoyang Wang, New Providence, NJ (US)

(21) Appl. No.: 16/158,097

(22) Filed: Oct. 11, 2018

(51) Int. Cl. G06K 9/62; G06K 9/46

(52) U.S. Cl. CPC G06K 9/6262; G06K 9/6256; G06K 9/4642; G06K 9/4604

(57) ABSTRACT

The present disclosure is directed to a method to generate a recovered image from a compressive measurement vector. The method uses a trained machine learning (ML) model, generated from a decomposed sensing matrix and a compressive measurement labeled pair, to generate a feature vector that has a dimensional value less than that for the recovered image. The feature vector can be linearly transformed into the recovered image. Also disclosed is a system operable to execute a process to train a ML model using a decomposed sensing matrix, a training image, and a compressive measurement vector representing the training image. A system is also disclosed that is operable to utilize a trained ML model and a decomposed sensing matrix to estimate a recovered image represented by a compressive measurement vector.

### TECHNICAL FIELD

The present disclosure is directed to systems and methods for image processing. More particularly, the present disclosure is directed to machine learning based compressive sensing image processing.

### BACKGROUND

Digital image/video cameras acquire and process a significant amount of raw data that is reduced using compression. In conventional cameras, raw data for each of an N-pixel image representing a scene is first captured and then typically compressed using a suitable compression algorithm for storage and/or transmission. Although compression after capturing a high resolution N-pixel image is generally useful, it requires significant computational resources and time.

A more recent approach, known in the art as compressive sensing of an image or, equivalently, compressive imaging, directly acquires compressed data for an N-pixel image (or images in case of video) of a scene. Compressive imaging is implemented using algorithms that use random projections to directly generate compressed measurements for later reconstructing the N-pixel image of the scene without collecting the conventional raw data of the image itself. Since a reduced number of compressive measurements are directly acquired in comparison to the more conventional method of first acquiring the raw data for each of the N-pixel values, compressive sensing significantly eliminates or reduce resources needed for compressing an image after it is fully acquired. An N-pixel image of the scene is reconstructed or recovered from the compressed measurements for rendering on a display or other uses.

### SUMMARY

One aspect provides a method to estimate a recovered image. In one embodiment, the method includes: (1) computing a feature vector from a received compressive measurement vector and a received trained machine learning (ML) model, wherein the feature vector has a first dimensional value that is smaller than a second dimensional value of an estimation of the recovered image, and (2) estimating the recovered image utilizing the feature vector and a linear transformation.

A second aspect provides for a computer program product having a series of operating instructions stored on a non-transitory computer-readable medium that directs a data processing apparatus when executed thereby to perform operations to generate a recovered image. In one embodiment, the computer program product includes: (1) computing a feature vector from a received compressive measurement vector and a received trained machine learning (ML) model, wherein the feature vector has a first dimensional value that is smaller than a second dimensional value of an estimation of the recovered image, and (2) estimating the recovered image utilizing the feature vector and a linear transformation.

A third aspect provides for a system for recovering a sensed image from compressive measurements. In one embodiment system includes: (1) a receiver, operable to receive a compressive measurement vector, a trained machine learning (ML) model, and a decomposed sensing matrix, wherein the compressive measurement vector represents the sensed image captured using compressive sensing, (2) a storage, operable to store the compressive measurement vector, the ML model, the decomposed sensing matrix, a feature vector, and a recovered image, and (3) a ML processor, operable to generate the feature vector utilizing the compressive measurement vector, the ML model, and the decomposed sensing matrix, and operable to transform the feature vector to the recovered image, wherein the feature vector has a dimensional value equal to a dimensional value of the recovered image minus a dimensional value of the compressive measurement vector.

### BRIEF DESCRIPTION

Reference is now made to the following descriptions taken in conjunction with the accompanying drawings, in which:

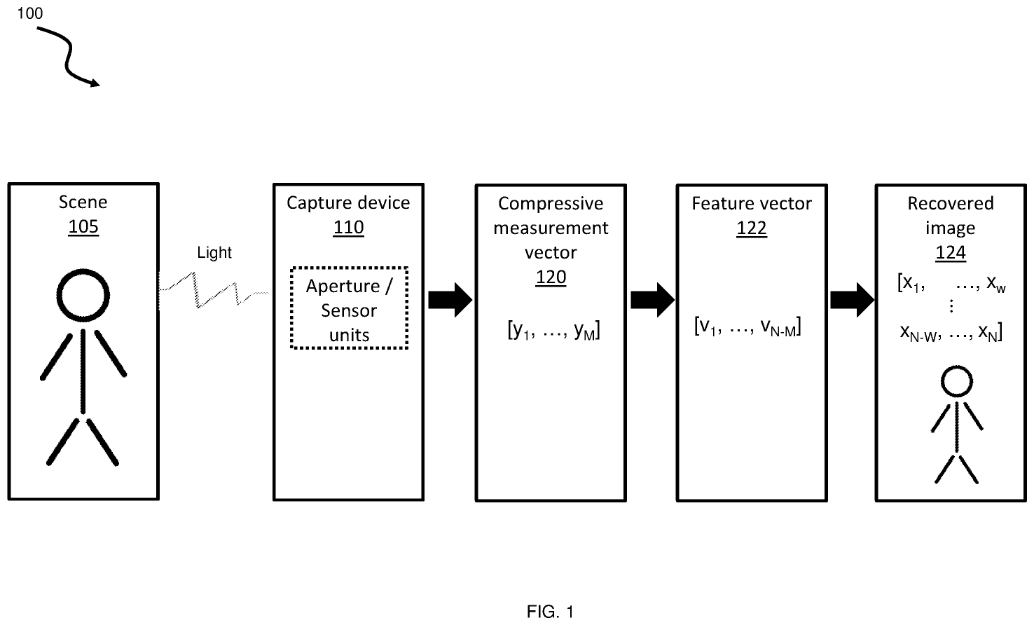

FIG. 1 is an illustration of a block diagram of an example capture and transformation process of a sample image;

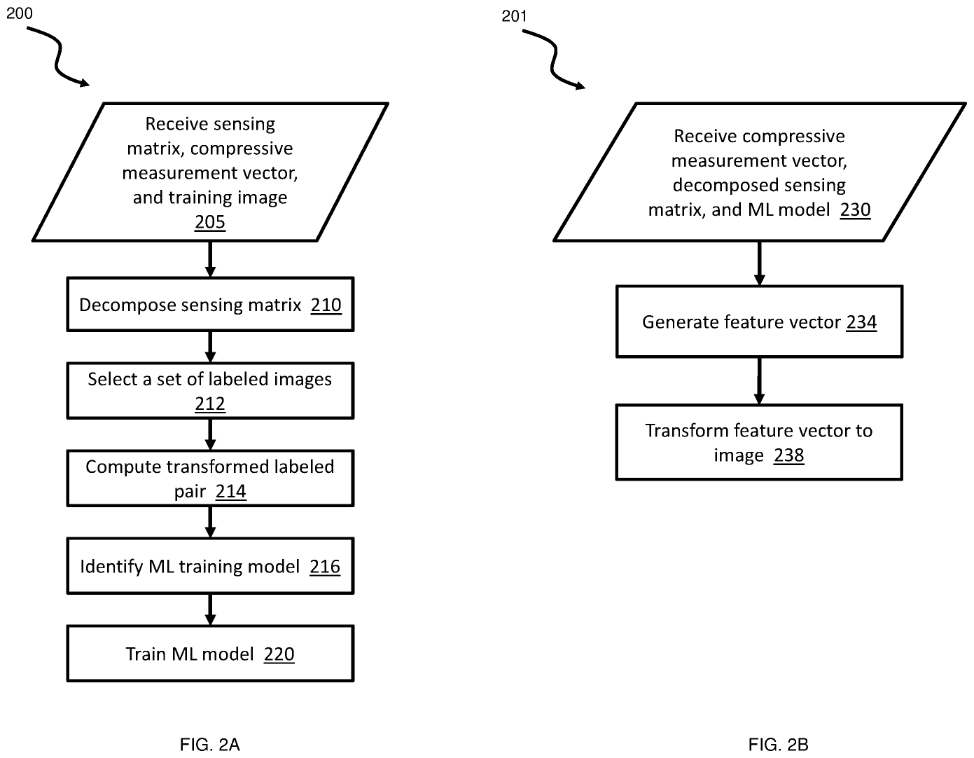

FIG. 2A is an illustration of a flow diagram of an example process to train a machine learning (ML) model;

FIG. 2B is an illustration of a flow diagram of an example process to generate a recovered image using a ML model;

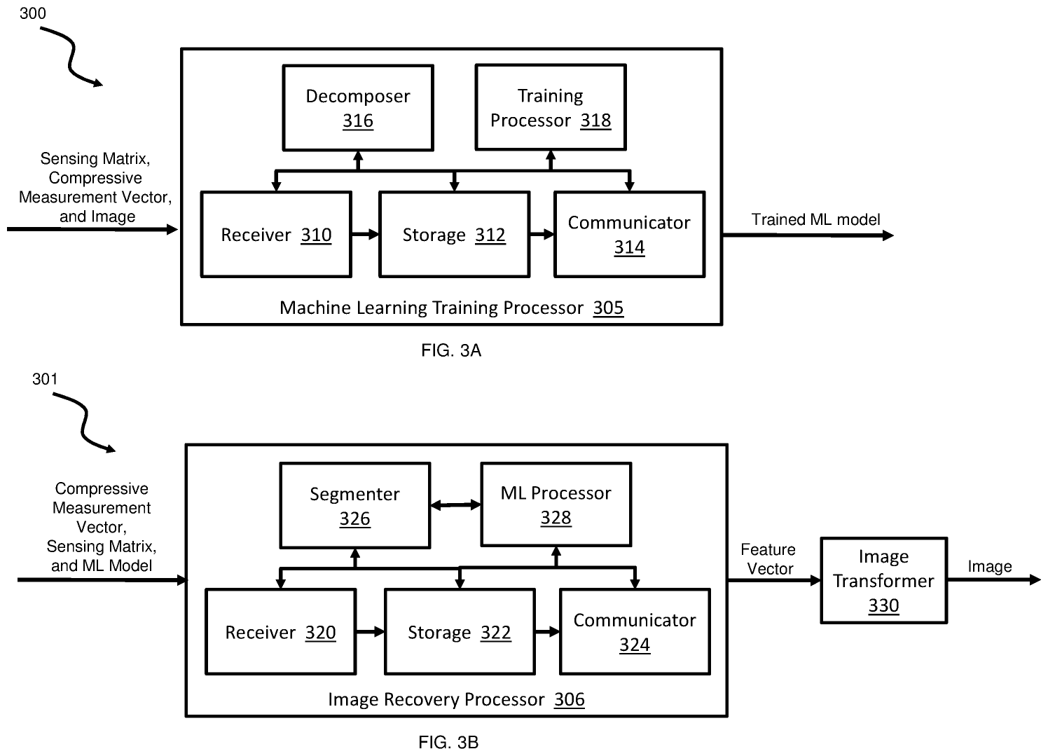

FIG. 3A is an illustration of a block diagram of an example ML training system;

FIG. 3B is an illustration of a block diagram of an example image recovery system;

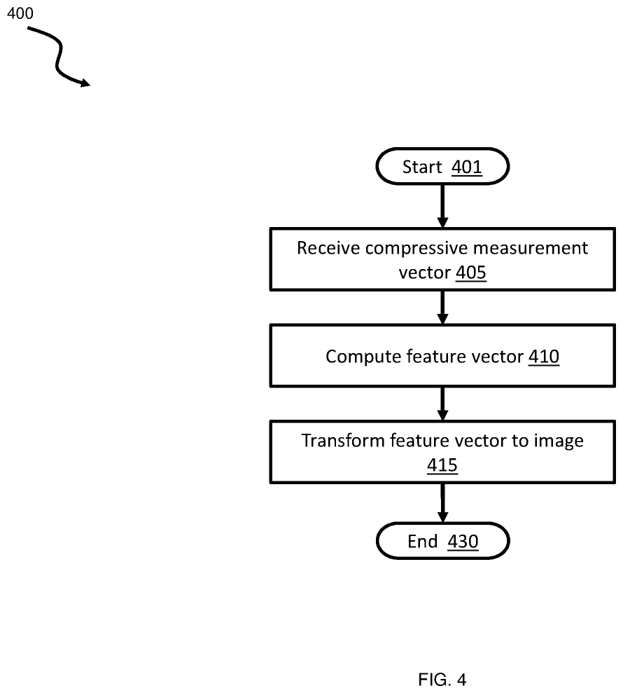

FIG. 4 is an illustration of a flow diagram of an example method to recover an image;

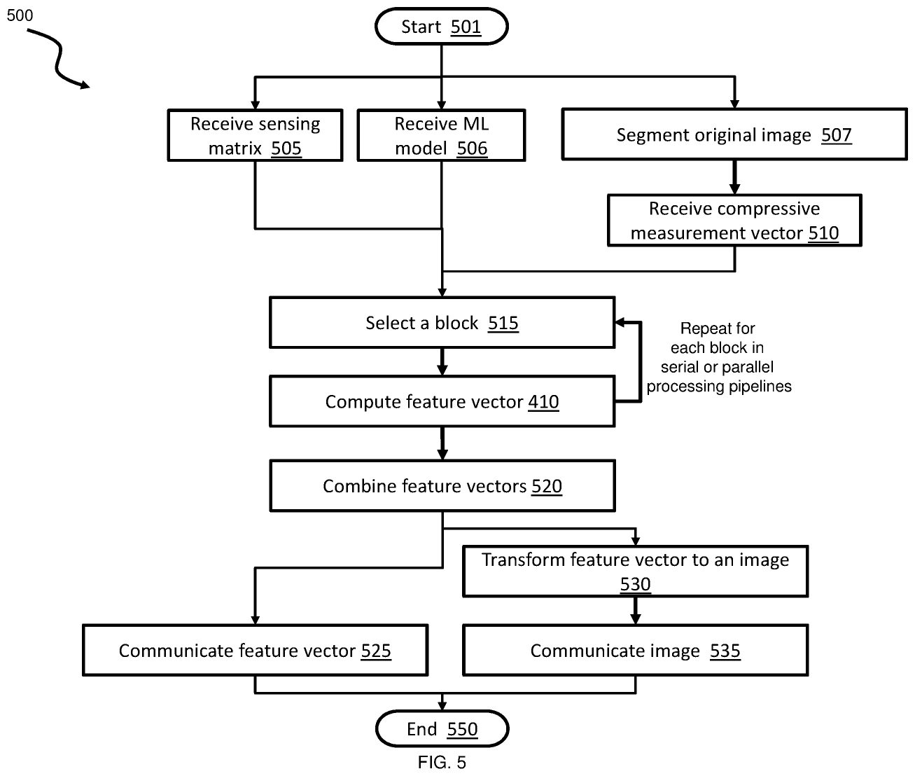

FIG. 5 is an illustration of a flow diagram of an example method, building on FIG. 4, to segment a compressive measurement vector; and

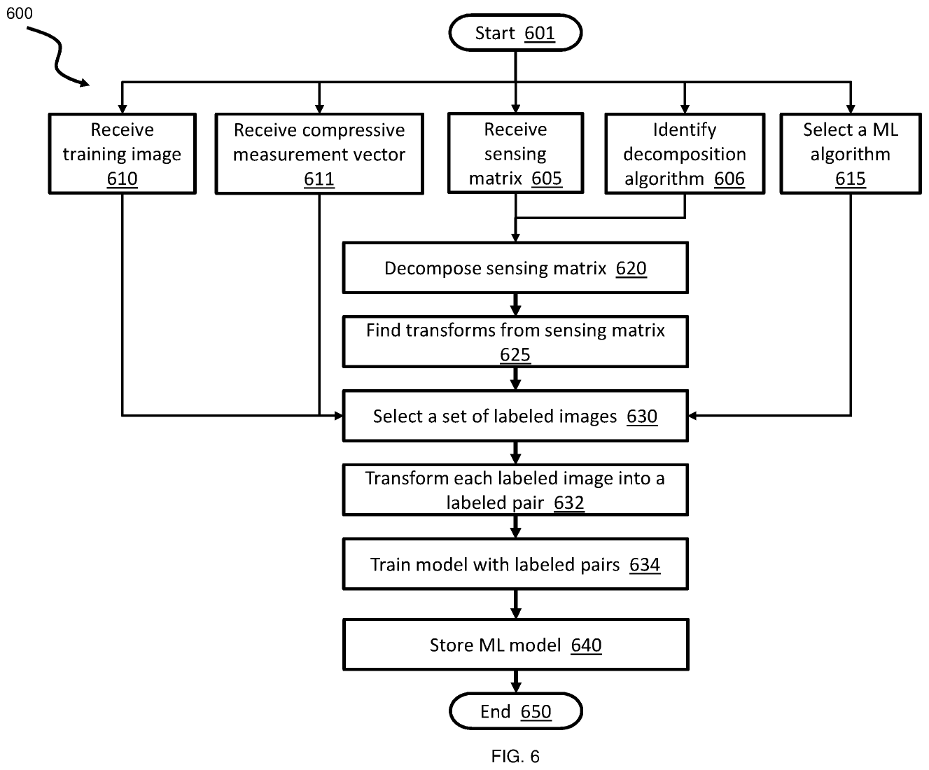

FIG. 6 is an illustration of a flow diagram of an example method to train a ML model.

### DETAILED DESCRIPTION

Various aspects of the disclosure are described below with reference to the accompanying drawings, in which like numbers refer to like elements throughout the description of the figures. The description and drawings merely illustrate the principles of the disclosure. It will be appreciated that those skilled in the art will be able to devise various arrangements that, although not explicitly described or shown herein, embody the principles and are included within spirit and scope of the disclosure.

As used herein, the term, “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

Compressive sensing, also known as compressed sampling, compressed sensing or compressive sampling, is a known data sampling technique which exhibits improved efficiency relative to conventional Nyquist sampling. Compressive sampling allows sparse signals to be represented and reconstructed using far fewer samples than the number of Nyquist samples. When a signal has a sparse representation, the uncompressed signal may be reconstructed from a small number of compressed measurements that are obtained using linear projections onto an appropriate basis. Furthermore, the reconstruction of the signal from the compressive measurements has a high probability of success when a random sampling matrix is used.

Compressive imaging systems are imaging systems that use compressive sampling to directly acquire a compressed image of a scene. Since the number M of compressive measurements that are acquired are typically far fewer than the number N of pixels of a desired image (i.e., M<<N), compressive measurements represent a compressed version of the N-pixel image. Compressive imaging systems conventionally use random projections to generate the compressive measurements, and the desired N-pixel image of the scene is obtained by converting the M number of compressive measurements into an N-pixel image. The N-pixel image of the scene that is reconstructed from the compressed measurements can be rendered on a display or subjected to additional processing.

Compressive sampling is generally characterized in matrix notation as multiplying an N dimensional signal vector by a M×N size sampling or sensing matrix y to yield an M dimensional compressed measurement vector, where M is typically much smaller than N (i.e., for compression M<<N). As is known in the art, if the signal vector is sparse in a domain that is linearly related to that signal vector, then the N dimensional signal vector can be reconstructed (i.e., approximated) from the M dimensional compressed measurement vector using the sensing matrix φ.

In imaging systems, the relationship between compressive measurements or samples yₖ (k ∈[1 . . . M]) that are acquired by a compressive imaging device for representing a compressed version of a one-dimensional representation of an N-pixel image x (x₁, x₂, x₃ . . . x_{N}) of a scene is typically expressed in matrix form as y=Ax (as shown below) where A (also known as φ) is a M×N sampling or sensing matrix that is implemented by the compressive imaging device to acquire the compressive sensing vector y.

$$[ \begin{matrix}{y}_{1} \\ {y}_{2} \\ {y}_{3} \\ ⋮ \\ {y}_{M}\end{matrix} ] = [ \begin{matrix}{a}_{1} [ 1 ] & {a}_{1} [ 2 ] & … & {a}_{1} [ N ] \\ {a}_{2} [ 1 ] & {a}_{2} [ 2 ] & … & {a}_{2} [ N ] \\ {a}_{3} [ 1 ] & {a}_{3} [ 2 ] & … & {a}_{3} [ N ] \\ ⋮ & ⋮ & ⋮ & ⋮ \\ {a}_{M} [ 1 ] & {a}_{M} [ 2 ] & … & {a}_{M} [ N ]\end{matrix} ] \cdot [ \begin{matrix}{x}_{1} \\ {x}_{2} \\ {x}_{3} \\ ⋮ \\ {x}_{N}\end{matrix} ]$$

There are various known approaches to transform a set of compressive measurements of a compressive sensed image into a conventional N-Pixel image that can be utilized by another process. For example, in one known approach, L1 minimization is used to recover an N-Pixel image from the M compressive measurements. More recently, machine learning (ML) approaches have been applied to recover an N-Pixel image from a conventionally compressed image (as opposed to a compressive sensed image). However, although ML techniques can be advantageous, a significant disadvantage of current ML implementations is that the dimensionality of the vectors that are input to the ML process and output by the ML process have the same N dimensionality as the desired N-pixel image and are thus computationally intensive. In addition, current ML techniques typically cannot be applied for recovering images when the compressed image is represented by compressive measurements that are obtained in a compressive imaging system (as opposed to conventionally compressed images).

This disclosure demonstrates a technique in which a lower dimensional M (where M<<N) linear compressive measurements representing a compressive sensed image are provided to a trained machine learning process where the output of the machine learning process produces feature vectors that also have smaller data dimensionality (N−M). The present disclosure thus describes a ML process that receives an M dimensional compressive measurement vector as input, and outputs an N−M dimensionality feature vector that is sufficient to recover an estimation of a desired N-Pixel image.

The systems and methods disclosed herein incur a number of additional advantages. For example, the process described below does not need to have information specific to the N-pixel image. Rather, the process described herein is applied to compressive measurements representing a compressive sensed image of a desired N-pixel image. Furthermore, as described below, the process satisfies the measurement constraint in that the recovered (i.e., estimated) N-pixel image can be used to recreate the compressive measurement vector from which the recovered image was derived. Further still, the ML model does not have to be retrained as long as the sensing matrix used to acquire the compressive measurements remains unchanged. These and other advantages are described in further detail below.

As noted above, the systems and methods disclosed herein use a trained ML model in which the ML model receives a compressive measurement vector y as input, and outputs a feature vector v, which is then transformed to an estimated image \tilde{x} representing a desired N-Pixel image x. The relationship between the estimated image recovered from the compressive measurements and the desired N-Pixel image may be thus expressed as A\tilde{x}=Ax=y. Equation 1 below illustrates the process for recovering an estimated image in equation form.

$$An illustration of the process to recover an image \\ \begin{matrix}y = Ax \to ML {\to }^{yields} v {\to }^{linear transform} \tilde{x} & \end{matrix} \qquad Equation 1$$

where y is a M dimensional compressive measurement vector that is input to a trained ML model,

A is the N×N dimensional sensing matrix, also called measurement matrix that has been pre-determined and used to acquire the compressive measurement vector y,

ML is the ML model,

x is a desired N-pixel image vector to be derived from the compressive measurement vector y;

v is the N−M dimensional feature vector which is the output of the trained ML model,

\tilde{x} is the N dimensional vector estimation of the image x that is generated from the feature vector matrix x, and

linear transform (described further below in Equation 9) utilizes the sensing matrix A in a decomposed form to transform the feature vector v into the estimated image \tilde{x}.

The dimensionalities noted above can be mathematically expressed as shown in Equation 2 below.

Equation 2: An example relationship of dimensional values of a compressive measurement vector and a corresponding sensing matrix

y ∈ [symbol] ^{M}, A ∈ [symbol] ^{M×N}, rank(A)=M,x ∈ [symbol] ^{N}, M<N

where [symbol] is the set of real numbers. This can result in a relationship of y^{dimension M}→[ML process]→>feature vector^{with dimension N-M→[transform]→recovered image \tilde{x}}^{dimension N}.

As noted previously, in contrast to the systems and methods disclosed herein, traditional ML approaches are significantly more computationally intensive because both the input and the output of such conventional approaches have a much higher dimensionality (typically N) than the process described herein, therefore requiring greater computational resources as would be readily appreciated by one of ordinary skill in the art.

In order to compute the set of features (i.e., feature vector v) from the compressive measurement vector, a ML process can be first trained. The present disclosure advantageously is not limited to a particular machine learning algorithm. In general, the ML training process includes selecting and training a ML model to generate a set of feature vectors using a pre-determined training set of labeled compressive sensed images. The selection of labeled compressive sensed images used for training the ML process in accordance with the present disclosure is described below (see Equation 3).

Equation 3: An example demonstrating the selection of a training set of labeled images

Ω={(x¹, y¹)|y¹=Ax¹, l∈ L}

where x¹, and y¹ represent each element in their respective matrix, where the pair of values satisfies the measurement constraint formula, and

l is a label in the set of L.

Each labeled image can be transformed into a labeled pair (see Equation 4).

Equation 4: An example demonstrating the transformation of the set of labeled images to labeled pairs

(y¹, v¹)=(y¹, [0 I_{(N-M)×(N-M)}]_{(N-M)×N}Dx¹), (x¹, y¹) ∈Ω

where v¹ is the desired feature vector to be output by the ML process,

I is the identity matrix, and

D is a portion of the decomposed sensing matrix A (see Equation 9 for the decomposition).

As illustrated in Equation 4 the training process for the ML model includes that for each pair of inputs (x¹, y¹) in the set of inputs, determine a labeled pair of (y¹,v¹) from y¹ and v¹ multiplied by a partial decomposition of the sensing matrix, and having the results further aligned by the illustrated matrix operations.

A ML model is trained as described in the example above using a set of labeled pair images and feature vectors. Advantageously, this training can be performed once for a particular sensing matrix, and, as noted previously, need not be performed again unless the sensing matrix A that is used to acquire the compressive measurements changes. Once the ML model has been trained for a sensing matrix, future or additional training for compressive measurements obtained using the same sensing matrix is not necessary. The training results in a trained ML model function that can generate the feature vector (see Equation 5).

$$An example demonstrating a function to generate \\ the feature vector \\ \begin{matrix}\vec{F} : {M}^{} {\to }^{yields} {N - M}^{} & \end{matrix} \qquad Equation 5$$

\vec{F}(y¹)=v¹=[0 I_{(N-M)×(N-M)}]_{(N-M)×N}Dx¹.

As noted above, the present disclosure is not limited to using a particular type of ML algorithm, and various ML algorithms can be trained and utilized, such as a convolutional neural network, radial basis network, and other known types of ML algorithms, without departing from the principles of the present disclosure. A change can be made to the conventional model where the original image element x is replaced by the compressive measurement vector y. This is demonstrated in Equation 6 showing an example neural network.

Equation 6: An example definition of a convolutional neural network demonstrating compressive measurement in place of image training

$$\vec{F} ( y ) = Θ ( y ; {W}_{i}^{{k}_{i}} , {C}_{j} ) = {W}_{c , {k}_{c}}^{T} {\sum }_{{k}_{c}} g ( {K}_{c}^{{k}_{c}} ⊗ {W}_{c - 1 , {k}_{c - 1}}^{T} {\sum }_{{k}_{c - 1}} g ( {K}_{c - 1}^{{k}_{c - 1}} ⊗ … {W}_{2 , {k}_{2}}^{T} {\sum }_{{k}_{1}} g ( {K}_{1}^{{k}_{1}} ⊗ ( {W}_{1 , {k}_{1}}^{T} y ) ) ) )$$

where linear weights W_{c,k}_{_{c}} ∈ [symbol] ^{L}^{_{c−1}}^{xL}^{_{c}} with L_{c}=N−M and kernals Kⱼ^{K}^{ⱼ} ∈ [symbol] ^{3×3} or [symbol] ^{5×5}. The element y in Equation 6 represents the compressive measurement vector.

Training the convolutional neural network can take the form as shown in the example equation in Equation 7.

$$An example training of the convolutional neural network to develop the model \\ {C}^{*} = {Dx}^{1} - Θ ( y ; {W}_{i}^{{k}_{i}} , {C}_{j} ) \qquad Equation 7$$

Another ML algorithm that can be used is a neural network model. This model is demonstrated in Equations 8A, 8B, and 8C.

$$An example definition of the neural \\ network model \\ θ ( y ; σ ) = {[ \begin{matrix}{σ}_{1} {e}^{- {σ}_{1}^{2} {‖ y - {y}^{1} ‖}^{2}} \\ ⋮ \\ {σ}_{T} {e}^{- {σ}_{T}^{2} {‖ y - {y}^{T} ‖}^{2}}\end{matrix} ]}_{Tx 1} \qquad Equation 8 A$$

where T=|Ω|,

$$\begin{matrix} σ = [ \begin{matrix}{σ}_{1} \\ ⋮ \\ {σ}_{T}\end{matrix} ] ∈ {T}^{} , and \\ y ∈ {M}^{} . & \\ An example training algorithm for the \\ neural network model \\ {P}^{*} = {\sum }_{l = 1 , … , T} {‖ {[ 0 {I}_{( N - M ) x ( N - M )} ]}_{( N - M ) xN} {Dx}^{l} - P \cdot Θ ( {y}^{l} ; σ ) ‖}^{2} & Equation 8 B\end{matrix}$$

where the algorithm attempts to find P ∈ [symbol] ^{(N-M)×T}.

Equation 8C: An example neural network model mapping

\vec{F}(y)=P*·Θ(y; σ)

where y ∈ [symbol] ^{M} and the mapping follows \vec{F}: [symbol] ^{M} → [symbol] ^{N-M}.

The sensing matrix A that is used to acquire the compressive measurement vector y is also not limited to a particular type of sensing matrix. In various embodiments, sensing matrix A can be a Toeplitz matrix, Hadamard matrix, a random matrix, a pseudo-random matrix, a randomly permutated Hadamard matrix, as will be appreciated by one or ordinary skill in the art. Sensing matrix A can be dependent on the hardware and software used to generate the compressive measurement vector y. For example, a sensing matrix can be developed for a certain model of a CT scan device. The same sensing matrix, and therefore, the same ML model, can be reused for other compressive measurement vectors that are generated by that CT scan model, across the individual CT scan devices. The same reuse of the sensing matrix and ML model can be applied to other devices that use the same process to generate the compressive measurement vector.

In the systems and methods disclosed herein, the sensing matrix A that was used to acquire the compressive measurements is decomposed and certain decomposed parts are used in both for training the ML model and for recovering or estimating the desired image from the feature vectors generated by the ML model. A full description of the decomposition of the sensing matrix A is now described below. In various embodiments, different methods may be used to decompose the sensing matrix, as long as the decomposition satisfies the constraint described in Equation 9. Once decomposed in accordance with Equation 9, the sensing matrix itself is not used to train the ML model or to recover an estimated image, and instead portions of the decomposition (as indicated in Equation 9) are used to train the ML model and to estimate the desired image. The decomposition step only needs to occur once and need not be repeated unless the sensing matrix itself is changed. An important advantage of the present system and method is that the decomposition is applied to the sensing matrix, and not to the compressive measurements. Further, the decomposition is applied only once, and is not repeated unless the underlying sensing matrix is changed.

The sensing matrix A can be decomposed into several other matrices as described by Equation 9. The decomposition satisfying Equation 9 may be achieve using various techniques such as Single Value Decomposition (SVD), Gaussian elimination, LU factorization, QR decomposition, or other decomposition algorithms.

Equation 9: An example sensing matrix decomposition

A=B[C 0]_{M×N}D,

where A is the sensing matrix on the left side of Equation 9, and the right side indicates the decomposition of the sensing matrix, where

B is an orthogonal matrix with the property B ∈ [symbol] ^{M×M},

C is a diagonal matrix with the property C ∈ [symbol] ^{M×M},

D is an orthogonal matrix with the property D ∈ [symbol] ^{N×N}, and

0 is the zero matrix with the property 0 ∈ [symbol] ^{M×(N-M)}.

Matrices B, C, and D are invertible. The linear transformation to obtain \tilde{x} from the feature vector v, using the decomposition of Equation 9 is defined in Equation 10, where it can be seen that parts of the decomposition matrices derived from the sensing matrix are used in the image recover process to estimate the desired image from the feature vectors generated by the trained ML model.

$$An example image recovery from compressive measurement vector \\ \tilde{x} = {D}^{- 1} [ \begin{matrix}{C}^{- 1} & {B}^{- 1} & y \\ & v & \end{matrix} ] \qquad Equation 10$$

where v is the feature vector from the ML model, i.e., \vec{F}(y).

The recovered feature vector v has a series of properties described in Equation 11. When combined with Equation 10, Equation 11 satisfies the measurement constraint formula described above of y=A\tilde{x}.

$$An example set of properties of the \\ compressive measurement \\ vector and feature vector A \tilde{x} = B [ C 0 ] D \tilde{x} = B [ C 0 ] [ \begin{matrix}{C}^{- 1} & {B}^{- 1} & y \\ & v & \end{matrix} ] = {BCC}^{- 1} {B}^{- 1} y = y \qquad Equation 11$$

As will be appreciated in view of the present disclosure, the sensing matrix provides a set of constraints relating to the original image. The decomposition process utilized for the sensing matrix provides a separation of the image space into a subspace where the original image is completely determined by the constraints, and a subspace where the original image may lie anywhere. It is the second subspace on which the ML training can be conducted.

In another aspect, the original sensed image can be segmented into blocks. This can be done to allow for more efficient processing of the compressive measurement vectors through the ML process, such as if a single compressive measurement vector would be too large to process efficiently. For example, the compressive measurement vector can be dimensionally sized to align with the size of registers, vector registers, data paths, cache bandwidth, memory allocations, and other factors of the computing system used to perform the ML process.

After segmenting the original sensed image, the processes as described herein can be applied to each block separately. This can be performed in a serial, parallel, or other computing pipeline process, as appropriate. For example, by segmenting into blocks, such as to the size of vector registers in a processor, each block can be processed by an assigned vector register in parallel thereby increasing the efficiency of generating the resultant feature vectors.

Turning now to the figures, FIG. 1 is an illustration of a block diagram of an example capture and transformation process 100 of a sample image. Process 100 starts with a scene 105, in this example, an image represented by the stick figure. Light from the scene can be captured by a capture device 110, using an aperture and sensor units. In this example, the capture device 110 can be a single pixel camera. Other capture devices can be utilized as well. Some capture devices can capture light, and others can use other types of electromagnetic, optical, sound, or other energy types.

The capture device can utilize a sensing matrix, for example, to control how the apertures on a single pixel camera are opened and closed for each capture time unit. In this aspect, the number of apertures can be N, and they can be opened and closed according to the pattern specified in the sensing matrix. Capture device 110 can output a set of compressive measurements as a compressive measurement vector 120. The compressive measurement vector can have M number of compressive measurements. The compressive measurement vector 120 represents the sensed image captured using compressive sensing. The sensing matrix used, which can typically be a sparse matrix, can indicate the number of compressive measurements taken by the capture device 110, i.e., the number of patterns controlling the apertures. In an alternative aspect, capture device 110 can be a conventional camera and the captured image can be transformed into a compressive measurement vector.

The compressive measurement vector 120 can be transformed into a feature vector stored in a matrix 122 using the ML model. This results in a feature vector 122, where the matrix has a dimensional value N−M. From the feature vector 122, a recovered image 124 can be generated. Recovered image 124 can be an estimation or approximation of the original image scene 105. The recovered image 124 can have a dimensional value of N, i.e., the number of elements in the aperture for a single pixel camera or the number of elements of the original captured image.

FIG. 2A is an illustration of a flow diagram of an example process 200 to train a ML model during the training phase. There are six basic steps to training the ML model. The process can start at a step 205 where the process can receive the sensing matrix identified for this training, a training sensed image, and a compressive measurement vector representing the sensed image. In the step 210, the sensing matrix can be decomposed using one of various conventional decomposers. For example, using SVD factorization, a sensing matrix A can be decomposed to B[C 0]_{M×N}D, as described in Equation 9. Proceeding to a step 212, a set of labeled images can be determined as demonstrated in Equation 3. In a step 214, a transformed labeled pair of image data can be computed, as shown in Equation 4. Step 216 allows for the identification of a ML model to use for training, for example the convolution neural network as described in Equation 6. Various models can be utilized, as described previously. Step 220 trains the ML model using the labeled pairs from step 214, as described in Equation 7.

FIG. 2B is an illustration of a flow diagram of an example a post-training process 201 to generate a recovered image using a ML model trained using the process illustrated in FIG. 2A. Process 201 demonstrates an example flow where the received input is a compressive measurement vector and the output is the recovered (i.e., estimated) image, as described in Equation 1. Starting with flow 230, the process receives the compressive measurement vector, a decomposed sensing matrix, and the ML model to generate the feature vector. Proceeding to flow 234, the compressive measurement vector can be transformed to a feature vector using the ML model and the decomposed sensing matrix. Finally, in flow 238, the feature vector can be linearly transformed to produce the recovered image, as described in Equation 10.

FIG. 3A is an illustration of a block diagram of an example ML training system 300. ML training system 300 includes a ML training processor 305 with a data input of a sensing matrix, a compressive measurement vector, and an output of a trained ML model. ML training processor 305 is a description of the logical features of the processor and each of the features can be implemented using one or more processors, chips, algorithms, systems, and other computing constructs. The features can be located proximate to one another, separate from one another, or a combination thereof, where some features are located proximate to each other and other features located separately.

ML training processor 305 includes a receiver 310, a storage 312, a communicator 314, a decomposer 316, and a training processor 318. Receiver 310 can receive as input a sensing matrix, a training sensed image and the associated compressive measurement vector of the sensed image. Receiver 310 can store the received information in storage 312. Storage 312 can be a conventional storage system, for example, a cache, system memory, database, USB key, hard drive, data center, or other type of storage medium.

Decomposer 316 can take the received sensing matrix, such as from the receiver 310 or from storage 312, and apply a selected decomposition algorithm. The resultant decomposition can be provided directly to the training processor 318 or stored in storage 312. Training processor 318 can utilize the received compressive measurement vector and the decomposed sensing matrix to train the ML model. The trained ML model can be stored in storage 312. Communicator 314 can communicate the trained ML model to another process, system, or to another storage medium.

FIG. 3B is an illustration of a block diagram of an example image recovery system 301. Image recovery system 301 includes image recovery processor 306 with an input of a compressive measurement vector, a decomposed sensing matrix, an optional original sensed image, and a ML model, and an output of a feature vector. Image recovery processor 306 is a description of the logical features of the processor and each of the features can be implemented using one or more processors, chips, algorithms, systems, and other computing constructs. The features can be located proximate to one another, separate from one another, or a combination thereof, where some features are located proximate to each other and other features located separately.

Image recovery processor 306 includes a receiver 320, a storage 322, a communicator 324, a segmenter 326, and a ML processor 328. Receiver 320 can receive as input the input information as described above. Receiver 320 can store the received information in storage 322. Storage 322 can be a conventional storage system, for example, a cache, system memory, database, USB key, hard drive, data center, or other type of storage medium.

Segmenter 326 can take the original sensed image, such as from the receiver 320 or from storage 322, and segment it into blocks, as appropriate for the computing system being used for this process. Segmenter 326 is an optional component. The original sensed image does not need to be segmented into blocks, effectively treating it as a single block. The segmenter 326 can then compute the compressive measurement vector for each block of the original sensed image.

The resultant blocks can be provided directly to the ML processor 328 or stored in storage 322. ML processor 328 can utilize the received or computed compressive measurement vector, and apply the appropriate ML model that was previously computed for the sensing matrix, where that sensing matrix was utilized in generating the compressive measurement vector. ML processor 328 can output a feature vector. The feature vector can be stored in storage 322. Communicator 324 can then communicate the feature vector to another process, system, or to another storage medium.

FIG. 4 is an illustration of a flow diagram of an example method 400 to recover an image. Method 400 starts at a step 401 and proceeds to a step 405. At the step 405, the method 400 can receive the compressive measurement vector y, the ML model to use, and the decomposed sensing matrix. In a step 410, the compressive measurement vector y can be processed through the ML model to generate a feature vector, i.e., v=\vec{F}(y). Steps 405 and 410 can be repeated for each element in the compressive measurement vector. The repeating process can be executed serially, in parallel, or in some other combination, with the intent to improve the computing efficiency. Proceeding to a step 415, the feature vector can be transformed to the recovered image (see Equation 10). The method 400 ends at a step 430.

FIG. 5 is an illustration of a flow diagram of an example method 500, building on FIG. 4, to segment a compressive measurement vector. Method 500 builds on some of the steps from method 400. Method 500 starts at a step 501 and proceeds to steps 505, 506, and 507. In the step 505, the method can receive the sensing matrix to be used, in its regular form or decomposed form. If the sensing matrix is received in regular form, then the sensing matrix can be decomposed in this step. In the step 506, the method can receive the ML model to be used. Various ML models can be trained and stored for later use. The ML models can be stored in a conventional storage, such as memory, a database, a hard disk, or other storage medium or device.

In the step 507, the method 500 can segment the original sensed image into blocks. The block size is typically determined by factors involving how the computing system will be processing the compressive measurement vector, for example, the size of cache memory, the size of registers, the size of vector registers, the size of data pipelines, and other factors. The block size can be modified to increase computing efficiency. There can be one or more blocks. Step 507 is optional as the original sensed image does not need to be segmented into blocks. Steps 505, 506, and 507 can be executed in serial, parallel, or a combination order.

In the step 510, the method can receive or compute the compressive measurement vector representing the sensed image. There can be one computed compressive measurement vector for each block identified in step 507. If no blocks were identified in step 507, the step 510 can receive the compressive measurement vector from another location. After steps 505, 506, and 510 have completed, the method 500 proceeds to a step 515.

In a step 515, one of the segmented blocks, or the entire compressive measurement vector if no blocks are utilized, can be selected for processing. Proceeding to the previously described step 410, the method 500 proceeds as described above to compute the feature vector. At the end of step 410, the process flow is modified. Step 410 is repeated for each of the compressive measurement vectors, one for each of the segmented blocks, or the entire compressive measurement vector if no block segmentation is utilized. Once the compressive measurement vector for the block has been processed, the method 500 loops back to step 515 to select another block for processing, if there are additional blocks to process. Once the blocks have been processed, the method 500 proceeds to a step 520. The block processing steps 515 and 410 can be processed in a serial, parallel, or a combination thereof, pipeline.

Proceeding to the step 520, the feature vectors computed from steps 515 and 410, can be combined to create the resultant feature vector. Proceeding from the step 520, the method 500 can proceed to a step 525 r a step 530. In the step 525, the resultant feature vector can be communicated to another method, process, or system, such as a storage medium or processing unit. The method ends at a step 550.

In the step 530, the resultant feature vector can be transformed into an image matrix, i.e., an estimation of the image. Proceeding to a step 535, the image matrix can be communicated to another method, process, or system, such as a display device or storage medium. The method ends at the step 550.

FIG. 6 is an illustration of a flow diagram of an example method 600 to train a ML model. Method 600 begins at a step 601 and proceeds to various steps that can be executed using serial, parallel, or a combination of processes. In a step 605, the sensing matrix can be received. In a step 606, a decomposition algorithm can be identified. Steps 605 and 606 can be executed using serial or parallel processing. After both steps 605 and 606 have completed, the method 600 proceeds to a step 620. In the step 620, the sensing matrix can be decomposed per the algorithm identified. Proceeding to a step 625, the decomposed transforms of the sensing matrix are identified.

Returning to the step 601, steps 610, 611, and 615 can be executed using serial, parallel, or a combination of processes. In the step 610, a training image can be received. This step should be completed prior to step 630 and is not dependent on a step prior to 630. In the step 611, a compressive measurement vector, representing the sensed image received in step 610, can be received. This step should be completed prior to step 630 and is not dependent on a step prior to step 630. In the step 615, a ML algorithm can be identified and the ML model received. This step should be completed prior to step 630 and is not dependent on a step prior to 630.

After steps 610, 611, 615, and 625 have been completed, the method 600 proceeds to a step 630. In the step 630, a set of labeled images is selected (see Equation 3). In a step 632, each labeled image is transformed into a labeled pair (see Equation 4). In a step 634, the ML model is trained utilizing the labeled pairs (see Equations 6 and 7). Once the labeled pairs have been processed and trained, then the method proceeds to a step 640. In the step 640, the ML model is stored in a storage medium, or communicated to another method, process, or system. The method 600 ends at a step 650.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. A method to estimate a recovered image, comprising:
computing a feature vector from a received compressive measurement vector, and a received trained machine learning (ML) model, wherein said feature vector has a first dimensional value that is smaller than a second dimensional value of an estimation of said recovered image; and
estimating said recovered image utilizing said feature vector and a linear transformation.

2. The method as recited in claim 1, wherein said computing further comprises:
segmenting an original image into blocks, wherein one or more of said compressive measurement vectors are computed from said original image; and
processing each of said blocks utilizing a serial or parallel pipeline.

3. The method as recited in claim 1, wherein said first dimensional value is equal to said second dimensional value, minus a third dimensional value of said compressive measurement vector.

4. The method as recited in claim 1, further comprising:
transmitting said recovered image to a storage medium or to a display.

5. The method as recited in claim 1, wherein said linear transformation utilizes a decomposition of a sensing matrix.

6. The method as recited in claim 5, wherein said ML model is trained utilizing said decomposition.

7. The method as recited in claim 5, wherein said sensing matrix is a Toeplitz, Hadamard, a random matrix, a pseudo-random matrix, or a randomly permutated Hadamard matrix.

8. The method as recited in claim 5, wherein said sensing matrix is determined by selecting discrete entries from said sensing matrix utilizing a determined pattern.

9. The method as recited in claim 5, further comprising:
decomposing, prior to training said ML model, said sensing matrix utilizing one of a singular value decomposition, Gaussian elimination, QR decomposition, or lower-upper (LU) factorization.

10. The method as recited in claim 9, further comprising:
generating a set of transformed labeled pairs utilizing said decomposed sensing matrix, a training image, and a second compressive measurement vector representing said training image.

11. The method as recited in claim 10, further comprising:
training said ML model, prior to said computing, wherein said training utilizes said transformed labeled pairs.

12. A computer program product having a series of operating instructions stored on a non-transitory computer-readable medium that directs a data processing apparatus when executed thereby to perform operations to generate a recovered image, said operations comprising:
computing a feature vector from a received compressive measurement vector and a received trained machine learning (ML) model, wherein said feature vector has a first dimensional value that is smaller than a second dimensional value of an estimation of said recovered image; and
estimating said recovered image utilizing said feature vector and a linear transformation.

13. The computer program product as recited in claim 12, wherein said computing further comprises:
segmenting an original image into blocks, wherein one or more of said compressive measurement vectors are computed from said original image; and
processing each of said blocks utilizing a serial or parallel pipeline.

14. The computer program product as recited in claim 12, wherein said first dimensional value is equal to said second dimensional value, minus a third dimensional value of said compressive measurement vector.

15. The computer program product as recited in claim 12, operations further comprising:
transmitting said recovered image to a storage medium or to a display.

16. The computer program product as recited in claim 12, wherein said linear transformation utilizes a decomposition of a sensing matrix, and wherein said ML model is trained utilizing said decomposition.

17. The computer program product as recited in claim 16, operations further comprising:
decomposing, prior to training said ML model, said sensing matrix utilizing one of a singular value decomposition, Gaussian elimination, QR decomposition, or lower-upper (LU) factorization.

18. The computer program product as recited in claim 17, operations further comprising:
generating a set of transformed labeled pairs utilizing said decomposed sensing matrix, a training image, and a second compressive measurement vector representing said training image.

19. The computer program product as recited in claim 18, operations further comprising:
training said ML model, prior to said computing, wherein said training utilizes said transformed labeled pairs.

20. A system for recovering a sensed image from compressive measurements, comprising:
a receiver, operable to receive a compressive measurement vector, a trained machine learning (ML) model, and a decomposed sensing matrix, wherein said compressive measurement vector represents said sensed image captured using compressive sensing;
a storage, operable to store said compressive measurement vector, said ML model, said decomposed sensing matrix, a feature vector, and a recovered image; and
a ML processor, operable to generate said feature vector utilizing said compressive measurement vector, said ML model, and said decomposed sensing matrix, and operable to linearly transform said feature vector to said recovered image, wherein said feature vector has a dimensional value equal to a dimensional value of said recovered image minus a dimensional value of said compressive measurement vector.

21. The system as recited in claim 20, wherein said recovered image is an estimation of said sensed image.

22. The system as recited in claim 20, wherein said sensed image is a video frame, a static or dynamic image, a set of electrical signals, a set of optical signals, or set of wireless signals.

23. The system as recited in claim 20, further comprising:
a segmenter, operable to segment said sensed image into blocks, and said generate said feature vector operates on each block utilizing serial or parallel processing.

24. The system as recited in claim 20, further comprising:
a communicator, operable to communicate said recovered image and said feature vector to a storage medium, display, or other system.

25. The system as recited in claim 20, further comprising:
a training processor, operable to generate said trained ML model utilizing said decomposed sensing matrix, a training image, and a second compressive measurement vector, representing said training image.
